(19) United States
(12) Patent Application Publication
(10) Pub. No.: US 2011/0022464 A1
(43) Pub. Date: Jan. 27, 2011

(54) OPTIMIZING ADS BY CUSTOMIZATION FOR A TARGET DEVICE

(75) Inventors: Melissa W. Dunn, Woodinville, WA (US); Gabriel Nanda, Bellevue, WA (US); Eric Picard, Redmond, WA (US); Eric Brun, Sammamish, WA (US); Aaron Bird, Seattle, WA (US); Rick Bohrer, Seattle, WA (US); Dan Schiappa, Bellevue, WA (US); Alam Ali, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/506,762

(22) Filed: Jul. 21, 2009

(51) Int. Cl. G06Q 30/00

(52) U.S. Cl. 705/14.52; 705/14.49; 705/14.72; 705/14.73; 705/14.53; 705/14.66; 705/14.61; 705/14.55; 705/14.64

(57) ABSTRACT

Computer systems, methods and media for optimizing an advertisement are provided. Creative elements for an ad campaign are received from an advertiser. In response to an ad call from a target device, device information, application information, and user information are accessed. Based on the accessed information and the creative elements of the dynamic creative, a customized ad is created that includes an optimized set of creative elements for the target device and the application such that the user gets an optimized user experience regardless of the target device presenting the ad.

### BACKGROUND

Typically, advertisers submit an advertisement (“ad”) set to a publisher. An ad set is a pre-bundled set of elements that make up an ad to be presented in the same way to all recipients. Advertisers are generally not able to customize their ads for every target device or audience since the production costs to create an ad for every product to be presented to every target device would be enormous. Thus, advertisers bundle the ad sets based on a most common denominator of recipients, i.e., the ad set is created in a way that works for the highest number of recipients. Advertisers simply hope that the ad set includes the right consumer characteristics to achieve the desired results, rather than submitting the elements of the ad set to an ad selection and delivery system to create an optimized ad based upon an individual user experience.

### SUMMARY

Embodiments of the present invention generally relate to systems, methods, and computer-storage media having computer-executable instructions embodied thereon that, when executed, perform methods for optimizing an ad. Utilizing the systems, methods, and computer-storage media described herein, a dynamic creative, which is a plurality of creative elements that are not bundled into a pre-defined ad set, is received from an advertiser or any entity that generates ads. Additionally, device information, application information, and user information is accessed. The combination of the accessed information and the dynamic creative allows for creation of an optimized ad including an optimized set of creative elements customized for a target device and/or a user. The ad is created including the optimized set of creative elements and presented to a user.

This Summary is provided to introduce a selection of concepts in a simplified form. The selection of concepts is further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a schematic diagram of an exemplary network operating environment suitable for use in implementing embodiments of the present invention;

FIG. 3 is a flow diagram illustrating a method for optimizing an ad, in accordance with an embodiment of the present invention;

FIG. 4 is a flow diagram illustrating a method for optimizing an ad, in accordance with an embodiment of the present invention; and

FIG. 5 is a flow diagram illustrating a method for optimizing an ad, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, embodiments of the present invention are described in detail below with reference to the attached drawing figures, which are incorporated in their entirety by reference herein.

In one embodiment, the present invention is directed to one or more computer-storage media having computer-executable instructions embodied thereon that, when executed, perform a method for optimizing an ad. The method includes receiving a dynamic creative including at least one asset and at least one rule. Device information for a target device that will receive the ad is accessed. A customized ad is created to be presented to a user such that the ad includes an optimized set of creative elements that have been customized for the target device. The ad with the optimized set of creative elements is then presented to the user.

In another embodiment, the present invention is directed to one or more computer-storage media having computer-executable instructions embodied thereon that, when executed, perform a method for optimizing an ad. The method includes executing an application on a target device and communicating an ad call from the target device. The target device receives a place-holder ad while a customized ad is created. Additionally, the target device receives a customized ad including an optimized set of creative elements that has been customized for the target device and the application.

In yet another embodiment, the present invention is directed to one or more computer-storage media having computer-executable instructions embodied thereon that, when executed, perform a method for optimizing an ad. The method includes receiving a dynamic creative including a plurality of creative elements from an advertiser. The plurality of creative elements includes at least one rule restricting a format, a layout, and a size of the ad; at least one asset to include in the ad, and at least one target audience requirement based on demographic information, behavioral information, or both. A first ad call is received from a target device. The first ad call is associated with a first application that is executed on the target device at the time of the first ad call.

Device information for the target device is then accessed. The device information includes a user associated with the target device, a screen size of the target device, and functional capabilities of the target device. First application information is also accessed for the first application. A first customized ad is created such that the first customized ad includes a first optimized set of creative elements for the target device and the first application. The first customized ad including the first optimized set of creative elements is presented to the user. A second ad call is received from the target device. The second ad call is associated with a second application that is executed on the target device at the time of the second ad call.

Device information for the target device, including a user associated with the target device, a screen size of the target device, and functional capabilities of the target device, is then accessed. Second application information is also accessed for the second application. A second customized ad is created such that the second customized ad includes a second optimized set of creative elements for the target device and the second application. The second customized ad including the second optimized set of creative elements is then presented to the user.

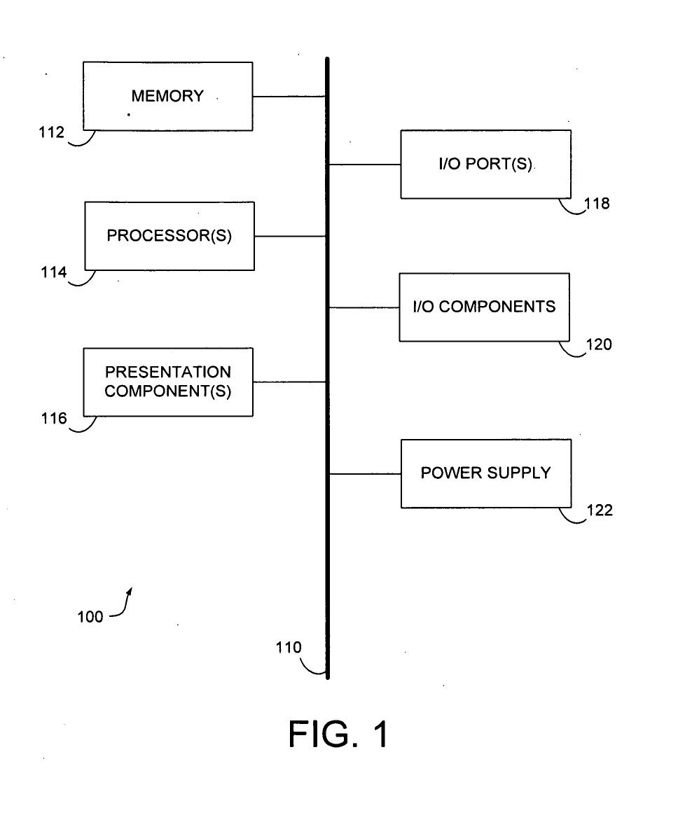

Having briefly described an overview of the present invention, an exemplary operating environment in which various aspects of the present invention may be implemented is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer-storage media and communication media. Computer-storage media includes both volatile and nonvolatile, removable and non-removable media implemented in any method or technology for storage of information such as computer-readable instructions, data structures, program modules or other data. Computer-storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100.

The memory 112 includes computer-storage media in the form of volatile and/or nonvolatile memory. The memory 112 may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, and the like.

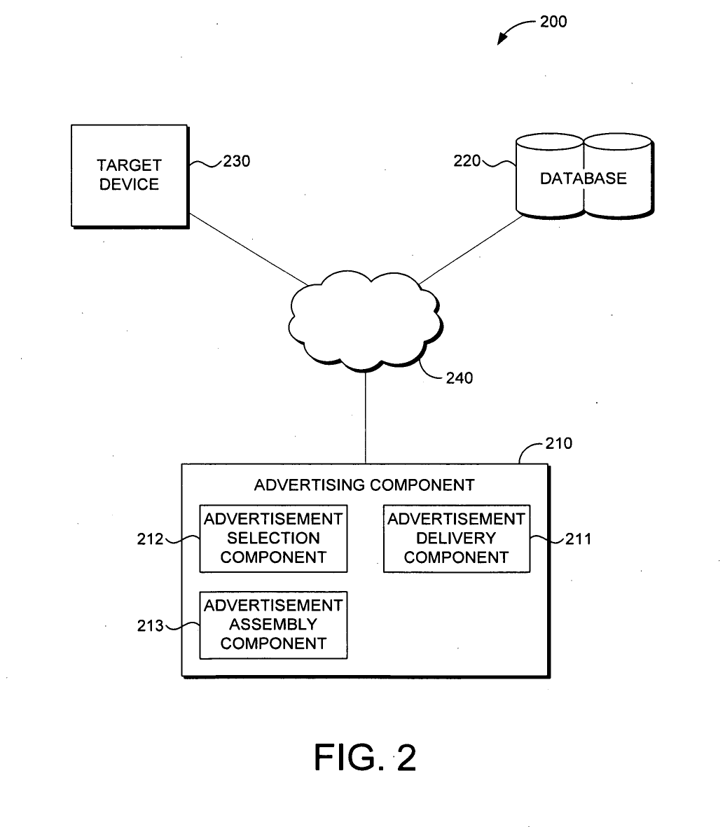

Embodiments of the present invention provide systems, methods, and computer-storage media having computer-executable instructions embodied thereon that, when executed, perform methods in accordance with embodiments hereof, for optimizing an ad. With reference now to FIG. 2, a schematic diagram is illustrated showing an exemplary computing system architecture 200 suitable for optimizing an ad, in accordance with an embodiment of the present invention. An ad, as used herein, refers generally to an announcement of goods or services offered to a user by an entity that is capable of generating ads. The computing system architecture 200 includes an advertising component 210, a database 220, and a computing device 230, all in communication with one another through a network 240. The network 240 may be wired, wireless, or both, and include, without limitation, one or more wide area networks (WANs), one or more local area networks (LANs), one or more public networks, such as the Internet, and/or one or more private networks. Such networking environments are commonplace in offices, enterprise-wide computer networks, intranets and the Internet. Accordingly, the network 240 is not further described herein.

The advertising component 210 may be any device that is capable of generating and/or communicating ads to be presented to users. Accordingly, the advertising component 210 may take on a variety of forms, such as a personal computer (PC), a laptop computer, a mobile phone, a personal digital assistant (PDA), a server, or any other device that is capable of generating and/or communicating an ad. In one embodiment, the advertising component 210 may be a computing device such as computing device 100 of FIG. 1.

Typically, advertisers submit an ad set, i.e., a pre-packaged ad ready to send to a user, based on criteria that makes the ad set accessible to the largest number of individuals. For instance, if more people will be able to view the ad with Flash Player capabilities, then the ad set will include Flash Player capabilities and all target devices, irrespective of their individual capabilities, will receive the ad with Flash Player features. Thus, a user using a target device without Flash Player will receive an ad that does not work and the user cannot view the ad as intended by the advertiser.

An ad set generally includes creative elements that may be included in the ad. A bundle of creative elements that are not yet pre-packaged in an ad is generally referred to herein as a dynamic creative. A dynamic creative typically includes all creative elements that could go into an ad. Creative elements include assets to be included in the ad and rules that restrict the way the ad is presented. Assets include images, text, videos, logos, and the like. Rules may determine the format of an ad (e.g., the placement of assets within the ad), the layout of an ad (e.g., portrait or landscape orientation), the size of an ad, and the like. An advertiser could submit a dynamic creative with a plurality of assets to be included and rules that restrict the presentation of the ad such that only certain assets will be presented depending on the rules. By way of example only, a dynamic creative could include an image of a car with four tires. A rule in the dynamic creative could say that the entire car should be presented if space permits. However, the rule could also state that if there is not enough space to show the car in its entirety, the ad should only depict a tire of the car.

By way of another example, a rule in a dynamic creative could require an ad to be presented with an image and a logo but also include a rule that determines which to present if both the image and the logo will not fit into the ad. In such a situation, only one of the two possible assets may be presented in the ad for a target device with a small ad space whereas a target device with a larger ad space may present both the image and the logo. Thus, an advertiser is able to submit a single dynamic creative to reach a plurality of target devices without any special action since an ad can be automatically customized in real-time for a target device by utilizing computing system architecture 200.

Further, since an advertiser submits one dynamic creative for an entire ad campaign, a user may have multiple exposures to the same ad campaign via a plurality of target devices. For instance, a user may receive an ad customized for his mobile phone from Advertiser X for Product Y and receive a similar ad for the same ad campaign from Advertiser X for Product Y on his television at a different time.

The advertising component 210 receives the dynamic creative, and the creative elements therein, from any entity that is capable of generating ads. The dynamic creative may then be stored in database 220. Database 220 may be integrated into advertising component 210 but is illustrated separately for the sake of clarity. The advertising component 210 also includes an ad delivery component 211, an ad selection component 212, and an ad assembly component 213 which are discussed in detail below.

Upon receiving the dynamic creative, the advertising component 210 may pre-render ads to present to users. Thus, ads may be customized and created for a target device prior to receiving an ad call from a target device. Pre-rendering a customized ad is possible since target devices have known functionalities and capabilities that allow the ad to be customized to the target device before the target device actually requests an ad. For instance, a high-definition television has a known capability of presenting a richer ad due to the high-definition feature. Ads can be customized with a richer content for the high-definition device. By way of further illustration, several mobile phones have capabilities to display a landscape screen view and ads may be customized for landscape viewing capabilities. Yet another example includes an application running on a target device with a known size of the application screen that is dedicated to ads such that the ads may not consume more than a set amount of the screen size (e.g., an application allows only twenty percent of the screen for ad space).

When the advertising component 210 determines that it is proper to pre-render various combinations of an ad from a dynamic creative, the advertising component 210 will identify possible combinations for the ad. The combinations are then evaluated in view of the rules included in the dynamic creative. By way of example only, assume a rule is included in the dynamic creative that states the ad should be text only if Flash Player capabilities are not available. The advertising component 210 may immediately pre-render (1) an ad that includes Flash Player features and (2) a text only version of the ad for a target device without Flash Player capabilities. Thus, pre-rending ads may be helpful for formatting ads. Once an ad has been pre-rendered for a variety of combinations, it may be stored in database 220. Some combinations of ads may be pre-rendered while other combinations for the same ad may be too cumbersome to create prior to receiving an ad call. Pre-rendering an ad sometimes is not desirable as there may be too many possibilities to effectively pre-render valuable ads. Additionally, it may be too costly to pre-render ads for target devices with few users.

In alternative embodiments, ads may be automatically rendered by the advertising component 210 in real-time rather than pre-rendered. In other words, the ad is not created until an ad call from a target device is received. A target device 230 may be any device that is capable of receiving an ad and/or generating an ad call. Accordingly, the target device 230 may take on a variety of forms, such as a personal computer (PC), a laptop computer, a mobile phone, a personal digital assistant (PDA), a server, a television, or any other device that is capable of receiving an ad. In one embodiment, the target device 230 may be a computing device such as computing device 100 of FIG. 1.

An ad call is a communication between target device 230 and advertising component 210 that notifies advertising component 210 that an ad should be communicated to target device 230. Generally, an ad call is communicated when an action is taken on the target device 230, for instance, an application is executed, an application is downloaded, a web resource is utilized, or the like. When the ad call is received from target device 230, the advertising component 210 automatically accesses device information for target device 230. Device information includes information specific to the target device communicating the ad call such as the size of the screen, a user associated with the target device, functional capabilities, performance capabilities, and the like. Real-time information is also communicated as device information such as the current battery reading of the target device (if applicable) and the current use of the target device (e.g., using an audio application). Real-time information on the current status of a target device is important to optimize a user experience with an ad. By way of example only, if a target device has a low battery it may not be desirable to present an ad including video content to the target device as it may exhaust the remaining battery life. Additionally, if an audio application is currently in use an advertiser would likely not be satisfied to know that a video application was presented on the target device when there is a high likelihood that the user did not view the ad. Thus, upon determining that the audio functionality is currently in use, the original ad including the video is still communicated to the target device in addition to an audio ad to increase the likelihood of exposure. Alternatively, only the audio ad may be presented to the user.

In addition to device information, application information may also be automatically accessed by advertising component 210. Application information is information associated with the application that is executed on target device at the time of the ad call. Application information includes the name of the application, the subject of the application (e.g., sports, news, music, entertainment, etc.), advertising restrictions, and the like. Exemplary advertising restrictions may be how often an ad is to be presented, how the ad is to be presented (e.g., audio or video), the amount of space within the application that may be occupied by the ad, and the like. Application information is useful to customize ads since an application developer has a stake in the ad presentation and the user's satisfaction with the ad in the application. Customization of ads intends to take the concerns of the developer into consideration and integrate the ad into the application for a useful, entertaining, and engaging user experience, while not interfering with the application experience.

Additional information that may be used to create the ad may be demographic information and behavioral information associated with the user and/or the target device. Demographic information includes age, gender, race, income, location, and the like. The advertiser may include target audience restrictions in the dynamic creative such that demographic information is necessary to ensure the proper audience is receiving the ads. Behavioral information includes patterns of the user that indicate potential interests or desires of the user. By way of example only, a user that executes various sports applications on a target device may be categorized as a sports fan. Demographic information and behavioral information may be associated with a user profile and stored in database 220. Demographic information and behavioral information may also be associated with a target device profile and stored in database 220. The demographic information and behavioral information may be resources used to further customize an ad for a user and/or a target device.

Once the target device information and/or the application information are accessed and analyzed, the advertising component 210 determines how to customize the ad to achieve an optimized set of creatives. The accessed information is communicated to the ad delivery component 211. The ad delivery component 211 organizes the creative elements of the dynamic creative and associates the dynamic creative with the accessed information from target device 230 and/or database 220. Any rules included in the dynamic creative are applied by the ad delivery component 211. The ad delivery component 211 then communicates the dynamic creative to an ad selection component 212.

The ad selection component 212 selects the creative elements within the dynamic creative that best fit the target device 230 (i.e., compatible with device information, compatible with application information, etc.) as well as meeting business requirements of the entity that submitted the dynamic creative. In other words, all creative elements from the dynamic creative are available to the ad selection component 212 and the ad selection component 212 determines which creative elements to use in the ad. The ad selection component 212 then communicates the selected creative elements to an ad assembly component 213. The ad assembly component 213 verifies that the ad content is appropriate with respect to creative elements submitted by the advertiser and with further respect to the target device information and/or the application information. Upon determining that the ad content is appropriate, the ad assembly component 213 creates a secure ad that is communicated to target device 230.

The customized ad communicated to target device 230 includes an optimized set of creative elements. The optimized set of creative elements includes the creative elements discussed above (e.g., assets, rules, and the like) but in a way that they are customized for the target device that made the ad call. By way of example only, an ad that is presented on a high-definition target device will include high-definition features while an ad presented on a target device without high-definition capabilities will not include high-definition features, such that both target devices are able to present the best possible ad for that particular target device.

In embodiments, in the time it takes to generate a pre-rendered ad or to deliver an ad created in real time, a place-holder ad may be presented on the target device such that the user is shown an ad immediately after communicating the ad call. The place-holder ad is also customized for the target device as it will be presented in an orientation-appropriate format for the target device. The place holder ad ensures that the user experience is instantaneous while more targeted ads are retrieved and/or created.

Upon receiving the customized ad, a user is able to interact with the ad. The ads may be controlled using gestures. Gestures, as used herein, generally refer to a way to control an ad by movement of the target device or by manipulation of items on the screen of the target device without pressing a button. For instance, an ad can be expanded by a user sweeping their fingers in an expanding motion while the size of an ad can be reduced by the user pinching their fingers together. Additionally, ads can also be controlled by means other than gestures for non-touch-enabled devices. Thus, an ad can be enlarged, minimized, moved, etc., by certain keystrokes. A user is also able to save assets within the ad, save the entire ad for later use, share the ad with other target devices, and the like.

In addition to increased interaction for users, customized ads may also include illustrative icons rather than the traditional hyperlinks or text. By way of example only, instead of a hyperlink for a click-to-call phone number, an icon of a phone may be presented such that the user can click the phone and be connected to the number included in the ad. Ads are thus more visually appealing and include the same valuable information.

Those skilled in the art will appreciate that the present invention contemplates the presence of additional components and/or subcomponents of the illustrated system 200, and the components and/or subcomponents may be combined with one another and/or separated into new components and subcomponents.

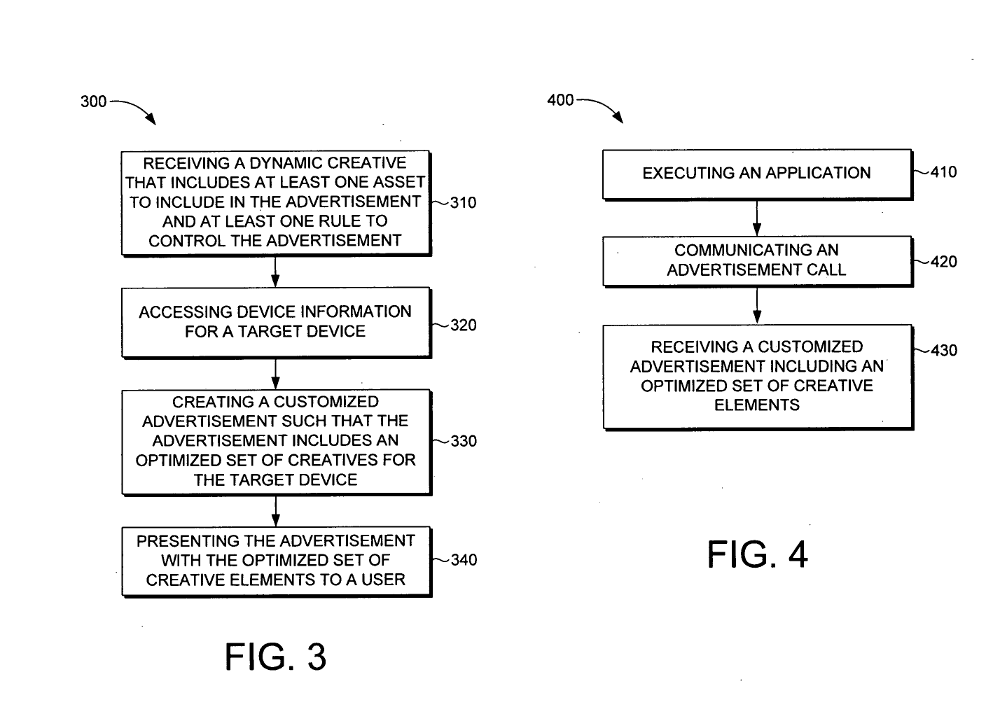

With reference now to FIG. 3, an exemplary method 300 for optimizing an ad is illustrated. Initially, as indicated at block 310, a dynamic creative is received (e.g., utilizing advertising component 210 of FIG. 2). The received dynamic creative includes at least one asset to include in the ad and at least one rule to control the ad. The at least one asset may be text, video, images, and the like. The at least one rule may restrict a format of the ad, a layout of the ad, a size of the ad, or a combination thereof. As indicated at block 320 device information for a target device is accessed. Device information includes information specific to the target device communicating the ad call such as the size of the screen, a user associated with the target device, functional capabilities, performance capabilities, battery capacity, current use of the target device, and the like. An ad to be presented to the user is created at block 330. The ad is created such that it includes an optimized set of creative elements for the target device. The optimized set of creative elements includes the at least one asset and is customized for the target device based on the device information. The customized ad with the optimized set of creative elements is presented to the user at block 340.

With reference now to FIG. 4, a flow diagram is illustrated showing a method 400 for optimizing an ad, in accordance with an embodiment of the present invention. Initially, as indicated at block 410, an application is executed on a target device. Execution of an application, as used herein, refers generally to any use of an application such as opening the application, downloading an application for a first time, and the like. An ad call is communicated from a target device (e.g., utilizing target device 230 of FIG. 2) at block 420. An ad call is a communication from a target device that an ad is required or desired. Upon communicating the ad call, the target device receives a place-holder ad at block 430. The place-holder ad ensures that a user has instantaneous ad exposure to an ad while a customized ad is retrieved and/or customized for the target device. A customized ad including an optimized set of creative elements is received at the target device at block 440. The optimized set of creative elements has been customized for the target device and the application based on device information and application information associated with the target device. Upon receiving the ad, the user is free to interact with it by use of gestures or keypad entries. The customized ad can be shared with other devices, saved for future use, and the like.

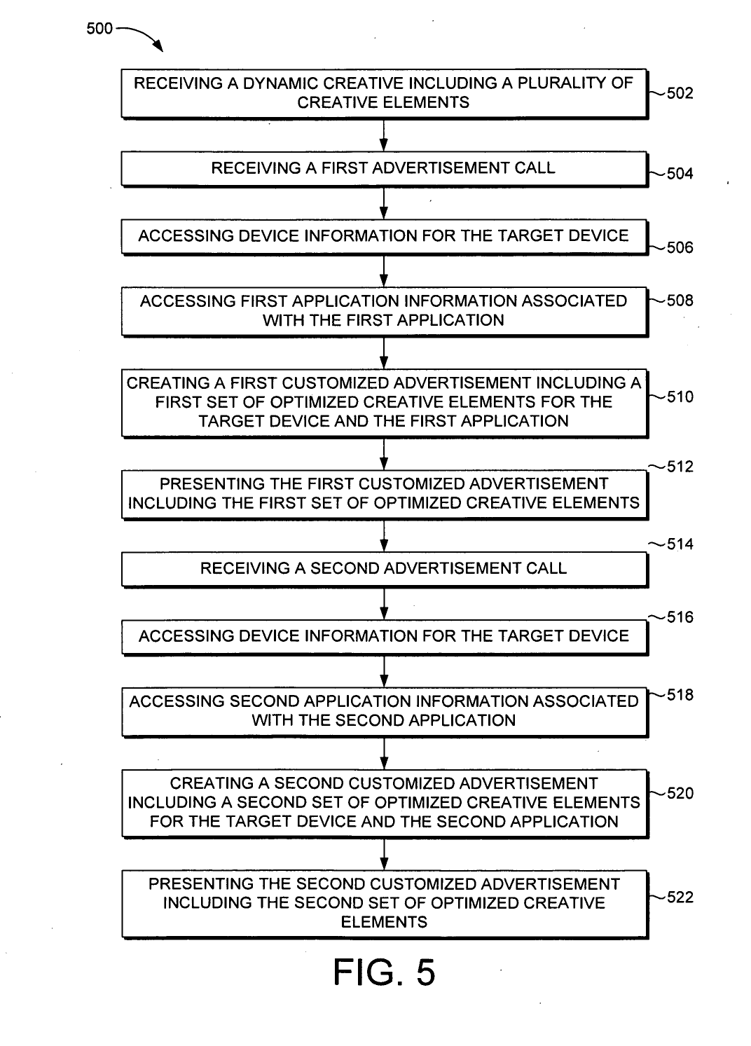

Referring now to FIG. 5, a flow diagram is illustrated showing a method 500 for optimizing an ad, in accordance with an embodiment of the present invention. Initially, as illustrated at block 502, a dynamic creative is received that includes a plurality of creative elements. The plurality of creative elements includes at least one restrictions the format, layout, and size of the ad; at least one asset to include in the ad; and at least one target audience requirement based on demographic information, behavioral information, or both. At block 504, a first ad call is received from a target device. The first ad call is associated with a first application that is executed on the target device at the time of the first ad call. Upon receiving the ad call, device information associated with the target device is accessed at block 506. The device information includes a user associated with the target device, a screen size of the target device, functional capabilities, performance capabilities, battery capacity, and current use of the device. Additionally, at block 508, first application information is accessed for the first application executed at the time of the first ad call. A first customized ad is created at block 510 based on the dynamic creative, the device information, and the first application information such that the first customized ad includes a first optimized set of creative elements for the target device and the first application. The first optimized set of creative elements includes the at least one asset and is customized for the target device and for the first application. The first customized ad including the first optimized set of creative elements is presented to the user at block 512.

As indicated at block 514, a second ad call is received from the target device at a time later than when the first ad call was received. The second ad call is associated with a second application that is executed on the target device at the time of the second ad call. The second application is different from the first application. Device information for the target device is accessed at block 516. Many of the elements included in the device information may be the same such as screen size, performance capabilities, etc., but the device information must be re-accessed since the battery capacity may have drastically changed, the target device may be used for a different purpose this time, and the like. Second application information associated with the second application is accessed at block 518. Since second application is different from first application, the application information for each will be different and must be re-accessed as the customization of the ad may change. For instance, if first application allowed an ad to occupy eighty percent of the screen size while second application allows ads to occupy eighty-five percent of the screen size, the customized ad for each application will differ. A second customized ad is created at block 520 based on the dynamic creative, the device information, and the second application information such that the second customized ad includes a second optimized set of creative elements for the target device and the second application. The second optimized set of creative elements includes the at least one asset and is customized for the target device and for the second application. The second customized ad created at block 520 may be the same of different than the first customized ad created at block 510, depending on the accessed information. The second customized ad including the second optimized set of creative elements is presented to the user at block 522.

The foregoing descriptions of embodiments of the invention are illustrative, and modifications in configuration and implementation will occur to persons skilled in the art. For instance, while the present invention has generally been described with relation to FIGS. 1-5, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

Having thus described the invention, what is claimed is:

1. One or more computer-storage media having computer-executable instructions embodied thereon that, when executed, perform a method for optimizing an advertisement, the method comprising:
receiving from an advertiser a dynamic creative that includes at least one asset to include in the advertisement and at least one rule to control the advertisement;
accessing device information for a target device that will receive the advertisement, wherein the device information includes at least a screen size of the target device;
creating the advertisement to be presented to a user such that the advertisement includes an optimized set of creative elements for the target device, wherein the optimized set of creative elements includes the at least one asset and is customized for the target device based on the device information; and
presenting the advertisement with the optimized set of creative elements to the user.

2. The one or more computer-storage media of claim 1, wherein the dynamic creative further includes an indication of a target audience.

3. The one or more computer-storage media of claim 2, wherein the indication for the target audience includes target behavioral information, target demographic information, or both.

4. The one or more computer-storage media of claim 1, wherein the at least one rule restricts a format of the advertisement, a layout of the advertisement, a size of the advertisement, or a combination thereof.

5. The one or more computer-storage media of claim 1, wherein the at least one asset is text, at least one video, or at least one image.

6. The one or more computer-storage media of claim 1, further including communicating an optimized set of creative elements to a plurality of target devices, wherein each optimized set of creative elements is customized for each target device of the plurality of target devices.

7. The one or more computer-storage media of claim 1, wherein device information further includes an associated user, a battery capacity, functional capabilities, and performance capabilities.

8. The one or more computer-storage media of claim 1, wherein the optimized set of creative elements include the creative elements within the dynamic creative, wherein the creative elements within the dynamic creative are customized for optimal presentation on the target device.

9. One or more computer-storage media having computer-executable instructions embodied thereon that, when executed, perform a method for optimizing an advertisement, the method comprising:
executing an application on a target device;
communicating an advertisement call from the target device; and
receiving at the target device a customized advertisement that includes an optimized set of creative elements, wherein the optimized set of creative elements has been customized for the target device and the application using device information and application information associated with the target device.

10. The one or more computer-storage media of claim 9, wherein device information includes the screen size of the target device, a user associated with the target device, a battery capacity associated with the target device, functional capabilities of the target device, and performance capabilities of the target device, or a combination thereof.

11. The one or more computer-storage media of claim 9, further comprising receiving a place-holder advertisement that is customized for a screen size of the target device, wherein the place-holder advertisement is replaced upon receiving the customized advertisement.

12. The one or more computer-storage media of claim 9, wherein the optimized set of creative elements is further customized using demographic information of a user associated with the target device, behavioral information of a user associated with the target device, or a combination thereof.

13. The one or more computer-storage media of claim 9, wherein the target device includes:
a mobile phone;
a personal data assistant; and
a television.

14. The one or more computer-storage media of claim 9, wherein the application information includes a name of the application, a subject of the application, and advertising restrictions of the application.

15. The one or more computer-storage media of claim 14, wherein advertising restrictions of the application include how often an advertisement is presented, a method of presentation, and a space that is occupied by the advertisement.

16. One or more computer-storage media having computer-executable instructions embodied thereon that, when executed, perform a method for dynamically creating an advertisement, the method comprising:
receiving from an advertiser a dynamic creative including a plurality of creative elements, wherein the plurality of creative elements includes:
(i) at least one rule restricting a format, a layout, and a size of the advertisement;
(ii) at least one asset to include in the advertisement; and
(iii) at least one target audience requirement based on demographic information, behavioral information, or both;
receiving a first advertisement call from a target device, wherein the first advertisement call is associated with a first application that is executed on the target device at the time of the first advertisement call;
accessing device information associated with the target device, wherein the device information includes a user associated with the target device, a screen size of the target device, and functional capabilities of the target device;
accessing first application information associated with the first application that is executed on the target device at the time of the first advertisement call;
based on the dynamic creative, the device information, and the first application information, creating a first customized advertisement such that the first customized advertisement includes a first optimized set of creative elements for the target device and the first application, wherein the first optimized set of creative elements includes the at least one asset and is customized for the target device and for the first application;
presenting the first customized advertisement including the first optimized set of creative elements to the user;
receiving a second advertisement call from the target device, wherein the second advertisement call is associated with a second application that is executed on the target device at the time of the second advertisement call, wherein the second application is different from the first application;
accessing device information associated with the target device;
accessing second application information associated with the second application that is executed on the target device at the time of the second advertisement call;
based on the dynamic creative, the device information, and the second application information, creating a second customized advertisement such that the second customized advertisement includes a second optimized set of creative elements for the target device and the second application, wherein the second optimized set of creative elements includes the at least one asset and is customized for the target device and for the second application;
presenting the second customized advertisement including the second optimized set of creative elements to the user.

17. The one or more computer-storage media of claim 16, wherein the at least one asset is text, at least one video, or at least one image.

18. The one or more computer-storage media of claim 16, wherein the first and second application information includes a name of the application and advertising restrictions of the application.

19. The one or more computer-storage media of claim 18, wherein advertising restrictions of the application include how often an advertisement is presented, a method of presentation, a space that is occupied by the advertisement, or a combination thereof.

20. The one or more computer-storage media of claim 16, wherein the target device is a mobile phone.
